(19) United States
(12) Patent Application Publication
(10) Pub. No.: US 2005/0240320 A1
(43) Pub. Date: Oct. 27, 2005

(54) No-load power test method and apparatus

(75) Inventors: Marty Franz, Portage, MI (US); William Wittliff, Gobles, MI (US)

Correspondence Address: BAKER & HOSTETLER LLP;Suite 1100, Washington Square, 1050 Connecticut Avenue, N.W., WASHINGTON, DC, 20036, US

(73) Assignee: SPX Corporation

(21) Appl. No.: 10/831,173

(22) Filed: Apr. 26, 2004

(51) Int. Cl. G06F 17/00

(52) U.S. Cl. 701/1; 701/29

(57) ABSTRACT

A method and apparatus for calculating power of an engine by determining a Moment of Inertia for the engine, accelerating the engine from a first RPM value to a second RPM value, determining a time difference between accelerating from the first RPM value to the second RPM value, and calculating the power as a function of the Moment of Inertia, the first RPM value, the second RPM value and the time difference.

### FIELD OF THE INVENTION

The present invention relates generally to computing power output measurements. More particularly, the present invention relates to quantifying power output of an engine based upon value measurements of revolutions per minute (RPM).

### BACKGROUND OF THE INVENTION

The manufacturing and servicing of engine platforms for vehicles may require measuring power output of the engine. Typically, dynamometers have been widely utilized for performing power measurements. Generally, dynamometers have been utilized within the vehicle manufacturing and servicing industries in the measurement of the horse-power of engines and motors. If the work is done on an object in a time, Δt, then the power, P, is the rate at which the work is done and may be expressed as:
P=W/Δt

If a value, F, represents the average value of a component of a force in a direction of a displacement, Δr, of its point of application, the product measures the work, W, done during the displacement:
W=(F)(Δr)

When the force acts on a body free to turn about a fixed axis, such as on a crankshaft component of an engine, the work done by a force after one revolution of the crankshaft component is the circumference of the crankshaft times the force:
W₁ᵣₑᵥ=2πrF

When an applied force F acts at an angle φ with respect to a position vector r locating a point of application of the force, a measurement of torque, τ, may be expressed as:
τ=rF sin(φ)

For calculating a direct measurement when the angle φ is at 90 degrees, the torque being produced by the engine is:
(r)(F)

Thus, the work done by a force after one revolution of the crankshaft component can be re-written in terms of the torque being produced by the engine as:
W₁ᵣₑᵥ=2πτ

After the engine has made Δn revolutions, the work done is:
W_{Δn revs}=2πτΔn

Thus, for the rate of work being done, the power, is calculated as:
P=(2πτΔn)/Δt

Typically, the speed of an engine is measured in revolutions per minute (rpm), which is related to revolutions per second by:
(Δn/Δt)=rpm/60

Thus, the power is:
P=2πτ(rpm)/60

In the British system of units, the units of power are ft-lb/sec. Since 1 horsepower is 550 ft-lb/sec, then, the horsepower of the engine is:
hp=2πτ(rpm)/60(550)
or
hp=(τ)(rpm)/5252

Hence, the horsepower of an engine can be derived from a measurement of its torque. One common method for measuring the power of an engine includes connecting the engine to a dynamometer. A dynamometer places a load on an engine and measures the amount of power that the engine can produce against the load. Mathematically:
1 horsepower=746 W

It is possible to gain an idea of how a dynamometer works using the following example. Using a dynamometer, one can apply a load to an engine at a prescribed RPM and measure the load the engine can handle at different engine speeds. By way of example, an engine may be revved to an RPM value wherein a dynamometer may be utilized to apply enough of a load to an engine to keep it at that RPM value, say 7,000, for example. One may record how much load the engine can handle at that RPM value. Subsequently, an additional load may be applied to reduce the engine speed down to 6,500 RPM. This load may also be recorded. It is further possible to apply an additional load to bring down the RPM value to 6,000, and so on. Alternatively, one may perform a similar operation starting down at a lower rpm value, for example, 500 or 1,000 rpm, and work up to higher RPM values by adjusting the load accordingly. What dynamometers actually measure is torque (in pound-feet). To convert a torque measurement, τ, into horsepower:
hp=(τ)(rpm)/5252

While the aforementioned dynamometer apparatus has proven to generate relatively accurate results for calculating power measurements, obtaining horsepower values as a function of torque may not always be feasible or convenient. Dynamometer equipment can be generally expensive to obtain and maintain within the vehicle manufacturing and service industry. Various components of the equipment utilized to obtain measurement values such as load cells or strain gauge type devices may also prove to be costly. The accuracy of results produced from the dynamometer may also be directly attributed to the maintenance of the machine including the calibration thereof between usage(s). Thus, poorly service and/or maintained dynamometer machines may be less likely to produce accurate results during operation.

Accordingly, it is desirable to provide a method and apparatus for quantifying power output of an engine, for example, based upon alternative measurements to dynamometers. It would be desirable for such measurements to be based upon readily available criteria to produce reasonably accurate results for measuring power.

### SUMMARY OF THE INVENTION

The foregoing needs are met, to a great extent, by the present invention, wherein in one aspect, a method and apparatus are provided that in some embodiments can provide a convenient calculation for estimating power of an engine preferably based upon readily available data.

In accordance with one aspect of the present invention, a method is provided that in some embodiments calculates power of an engine by determining a Moment of Inertia of an engine, accelerating the engine from a first RPM value to a second RPM value, and determining a time difference between accelerating from the first RPM value to the second RPM value. The method may also include calculating the power as a function of the Moment of Inertia, the first RPM value, the second RPM value and the time difference.

In accordance with another aspect of the present invention, a system for calculating power of an engine is provided that in some embodiments includes a means for receiving a first RPM value, a means for receiving a second RPM value, a means for receiving a Moment of Inertia value of an engine, and a means for receiving a time difference when the engine is accelerated from the first RPM value to the second RPM value. The system may also include a means for calculating the power as a function of the first RPM value, the second RPM value, the Moment of Inertia value and the time difference.

In accordance with yet another aspect of the present invention, a computer-readable medium for calculating power of an engine is provided that in some embodiments includes receiving a first RPM value, receiving a second RPM value, receiving a Moment of Inertia value of an engine and receiving a time difference when the engine is accelerated from the first RPM value to the second RPM value. The medium may also include calculating the power as a function of the value, the Moment of Inertial value and the time difference.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a flowchart illustrating steps that may be followed in accordance with one embodiment of a method or process according to a preferred embodiment of the present invention.

FIG. 2 is a schematic diagram of an automated system for calculating power in accordance with a preferred embodiment of the present invention.

FIG. 3 is a flowchart illustrating steps that may be followed in accordance with the automated system of FIG. 2.

### DETAILED DESCRIPTION

An embodiment in accordance with the present invention provides a method for calculating power of an engine using measurements characterized by RPM values over a period of time in combination with the moment of inertia of the engine. The method provides a convenient estimate of the power output form an engine without the use of a dynamometer. Furthermore, the calculation may be further incorporated within engine testing devices such as those sold as Vision Premier® or GENYSIS Scope Module available for SPX Corporation. Preferred embodiments of the invention will now be described with reference to the drawing figures, in which like reference numerals refer to like parts throughout.

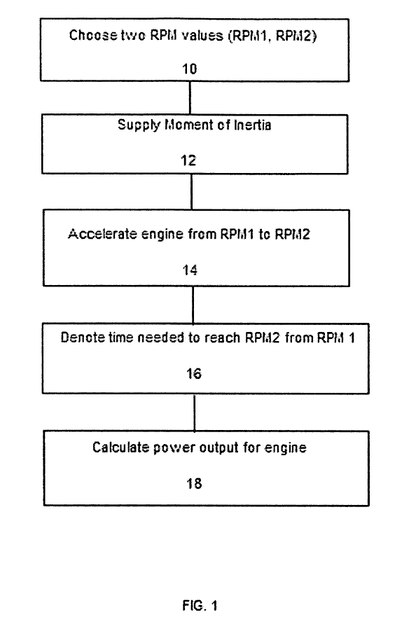

An embodiment of the present inventive process for calculating power of an engine is illustrated in FIG. 1. This embodiment comprises a calculation for computing power output of an engine as follows:
P=( 1/2)I(π/(9550×30))(n₂²−n₁²)(1/t)

The formula provides a convenient calculation for estimating power of an engine based upon readily available data. Namely, a formula for calculating the power includes variables of two RPM values (n₂,n₁) over a period of time (t) and a Moment of Inertia (I) for the engine. A technician is capable of using the formula to compute power, for instance, as a benchmark prior to performing a repair on a vehicle, perhaps for a variety of reasons including, for example, problems such as misfire, stumble, or lack of power. After a technician has completed a repair, the technician can perform another test and perform an additional power calculation in accordance with the present invention to verify whether the problem as been corrected. Such verification can include a comparative analysis of the original power value against a final power value after repairs and/or modifications have been performed on a vehicle. The ability to show the power calculation data beforehand and after and a comparison thereof can lend credibility to a final repair report.

Thus, in accordance with the present invention as shown in FIG. 1, a technician preferably chooses two RPM values 10, RPM₁ and RPM₂ for testing. The calculation of the present invention further requires supplying the Moment of Inertia of the vehicle 12. The Moment of Inertia may be calculated or simply supplied from engine specification sources including, for example, the Bosch Automotive Handbook, 5th Edition. In order to provide the time, t, needed to reach RPM₂ from RPM₁, the engine is accelerated from RPM₁ to RPM₂ 14. The time, t, needed to reach RPM₂ from RPM₁ is denoted 16. Hence, the Moment of Inertia, I, the two RPM values (RPM₁=n₁ and RPM₂=n₂,) and the time, t, are used to compute a power output 18 for the engine in accordance with the present invention.

The aforementioned power calculation may be programmed, for instance, by a software code written to emulate the formula for computing a power value. This software code may be further incorporated into a variety of testing devices including, for instance, external diagnostic and display devices know to those skilled in the art as Scan Tools utilized within the vehicle service and manufacturing industry.

Diagnostic devices may perform a variety of functions, including, for instance, being utilized as an engine analyzer. Diagnostic devices may generally contain input ports for responding to signals, for instance, generated from an onboard diagnostic computer (OBD) of a motor vehicle. The diagnostic device can be considered as a computer-readable medium which is capable of carrying one or a plurality of sequences and/or instructions. The computer-readable medium may further be linked, for example, to one or more processors to execute the aforementioned sequences and/or instructions to perform computer-implemented algorithms such as gathering and/or processing data. By coupling the diagnostic device to an engine, for example, through the motor vehicle onboard diagnostic computer, it is possible to collect and further access a variety of motor vehicle data through the capabilities of the processor driven software of the diagnostic device, for instance, as described herein.

Onboard control computers have become ubiquitous in motor vehicles, as safety, economy, and emissions requirements have continued to escalate, and convention designs for reciprocating engines, friction braking systems, collision safety apparatus, and traction control devices have proven unequal to the requirements set out in law and the implicit demands of competitor's achievements. Successive generations of onboard control computers have acquired increasing data sensing and retention capability as the electronic art has advanced.

It is desirable to select a diagnostic device, such as a Scan Tool, which is capable of at least providing means whereby fixed data elements from a vehicle's OBD computer and data from the OBD computer changing at any rate be gathered, scaled with respect to time delay, rate, and amplitude, then stored or displayed. Such data may include engine revolutions per minute (RPM) as a function of time during a particular test session. Such Scan Tools may include, for example, SPX Corporation's Vision Premier® or GENYSIS scope module.

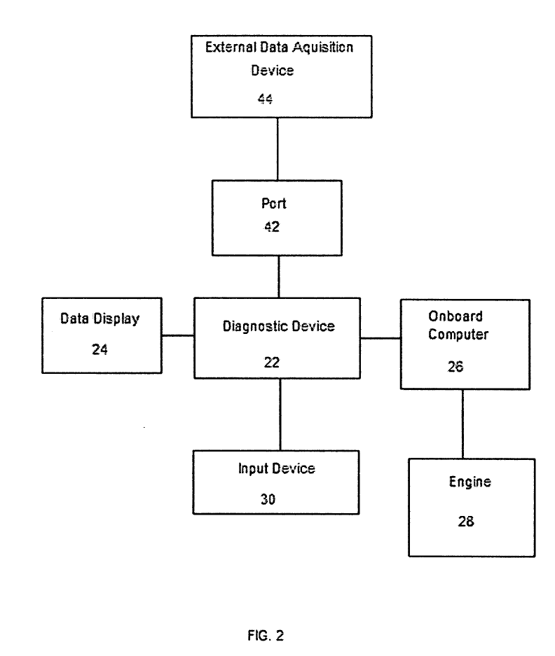

In a preferred embodiment, an automated system 20 for calculating power of a vehicle using a diagnostic device 22 is shown in FIG. 2. The diagnostic device 22 may provide a data display 24 for displaying data/information accessed from an OBD 26 of an engine 28 of a vehicle. Such data/information may be software driven, for instance, by graphical user interface (GUI)-based operating systems such as Lynx®, Apple® OS9®, and Microsoft® Windows®. Implemented within the software of the diagnostic device 22 may include a routine to calculate power of an engine in accordance with the present invention.

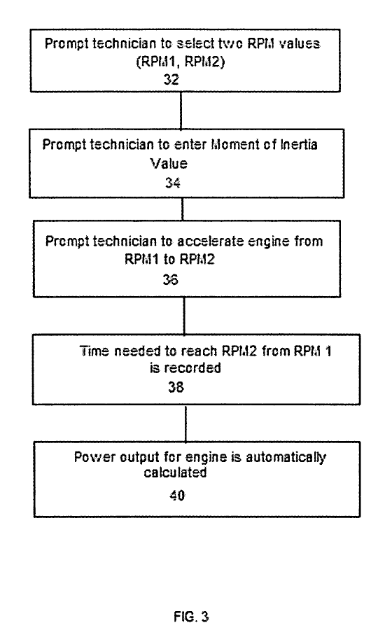

In a preferred embodiment, the software program of the diagnostic device 22 will prompt a technician to set two RPM values 32, RPM₁ and RPM₂ and to enter the Moment of Inertia of the vehicle 34 as shown in FIG. 3. The technician may use an input device 30 to enter the data of RPM 32 and Moment of Inertia Values 34. The input device 30 may include a keypad or keyboard, for examples, which can be preferably connected to the scan tool 22, by direct or wireless connection. Following the input of RPM values 32 and Moment of Inertia 34, the software routine will prompt the technician to accelerate the engine from RPM₁ to RPM₂ 36 whereupon the time, t, needed to reach RPM₂ from RPM₁ is recorded 38. Based upon the Moment of Inertia, I, the two RPM values (RPM₁=n₁ and RPM₂=n₂), and the time, t, a computation of power output for the engine may be automatically calculated 40 by the software routine of the diagnostic device 22 and displayed on the data display 24.

Although an example of the diagnostic device 22 is shown in the automated system 20, it will be appreciated that other embodiments of diagnostic devices can be used. These may include, for instance, diagnostic devices which may include ports 42, for example, to communicate with or receive information from external data acquisition devices 44. Such ports 42 may include custom interface connectors for an OBD adapter, a serial port connector, a USB port connector, an Infrared Data Association (IrDA)/Hewlett-Packard (HP) Infrared connection, a PCMCIA type 2 connector, a smart card connector, external flash memory, and a portable media card port or slot for receiving a portable media card such as a compact flash card, secure digital (SD) card, or multimedia (MMD) card. Hence, the aforementioned features incorporated into the diagnostic device 22 can facilitate the transmittal of data and processing of collected information.

One such advantage that can provide easy program upgrades, for example, and/or modification via remote updating, employs portable media card. A portable media card is preferably used to provide additional software programs for the diagnostic device. In an exemplary embodiment, the portable media card controls reading and/or writing functions to the internal and/or external flash memory. The portable media card can also interface with a portable media card port located on the diagnostic device.

Thus, in another embodiment the power calculation of the present invention can be emulated via software code and translated onto a portable media card such as the compact flash card, SD card, or MMD card, and subsequently run on a test instrument such as a diagnostic device for servicing engines.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A method of calculating power of an engine comprising:
determining a Moment of Inertia for the engine;
accelerating the engine from a first RPM value to a second RPM value;
determining a time difference between accelerating from the first RPM value to the second RPM value; and
calculating the power as a function of the Moment of Inertia, the first RPM value, the second RPM value and the time difference.

2. The method of claim 1, wherein the power is calculated as:
P=(½)I(π/(9550×30))(n₂²−n₁²)(1/t)
where I is the Moment of Inertia, n₁ is the first RPM value, n₂ is the second RPM value, and t is the time difference.

3. The method of claim 2, wherein the first RPM value and the second RPM value are predetermined prior to accelerating the engine.

4. A computer-readable medium for calculating power of an engine, the computer-readable medium carrying one or more sequences of one or more instructions which, when executed by one or more processors, causes the one or more processors to perform the computer-implemented steps of:
receiving a first RPM value;
receiving a second RPM value;
receiving a Moment of Inertia value of the engine;
receiving a time difference when the engine is accelerated from the first RPM value to the second RPM value; and
calculating the power as a function of the first RPM value, the second RPM value, the Moment of Inertia value and the time difference.

5. The medium of claim 4, wherein the power is calculated by:
P=(½)I(π/(9550×30))(n₂²−n₁²)(1/t)
where I is the Moment of Inertia, n₁ is the first RPM value, n₂ is the second RPM value, and t is the time difference.

6. The medium of claim 5, wherein the first RPM value and the second RPM value are predetermined prior to accelerating the engine.

7. The medium of claim 4, wherein the medium comprises:
a diagnostic device.

8. The medium of claim 7, wherein the diagnostic device comprises:
an engine analyzer.

9. The medium of claim 4, wherein the medium comprises:
a portable medium card.

10. The medium of claim 9, wherein the portable medium card comprises one of:
a compact flash card, a secure digital card and a multimedia card.

11. A system for calculating power of an engine, the system carrying one or more sequences of one or more instructions which, when executed by one or more processing means, causes the one or more processing means to perform computer-implemented steps of:
means for receiving a first RPM value;
means for receiving a second RPM value;
means for receiving a Moment of Inertia value of the engine;
means for receiving a time difference when the engine is accelerated from the first RPM value to the second RPM value; and
means for calculating the power as a function of the first RPM value, the second RPM value, the Moment of Inertia value and the time difference.

12. The system of claim 11, wherein the power is calculated by:
P=(½)I(π/(9550×30))(n₂²−n₁²)(1/t)
where I is the Moment of Inertia, n₁ is the first RPM value, n₂ is the second RPM value, and t is the time difference.

13. The system of claim 12, wherein the first RPM value and the second RPM value are predetermined prior to accelerating the engine.

14. The system of claim 11, wherein the system comprises:
a diagnostic device.

15. The system of claim 14, wherein the diagnostic device comprises:
an engine analyzer.

16. The system of claim 11, wherein the system comprises:
a portable medium card.

17. The system of claim 16, wherein the portable medium card comprises one of:
a compact flash card, a secure digital card and a multimedia card.

18. The system of claim 14, wherein the means for receiving a first RPM value, means for receiving a second RPM value, means for receiving a Moment of Inertia value of the engine, means for receiving a time difference when the engine is accelerated from the first RPM value to the second RPM value comprises:
an input device for entering the values into the diagnostic device.

19. The system of claim 18, wherein the input device comprises:
a keyboard connected to the diagnostic device.

20. The system of claim 19, wherein the keyboard is wireless.

21. The system of claim 19, further comprising:
a data display connected to the diagnostic device.

22. The system of claim 15, further comprising:
means for connecting to an onboard computer of a motor vehicle.

23. The system of claim 22, wherein the connecting means comprises:
a port for communicating with the system.
